(19) United States
(12) Patent Application Publication
(10) Pub. No.: US 2026/0251955 A1
(43) Pub. Date: Aug. 27, 2026

(54) SYSTEMS FOR VIDEO PRODUCTION LIGHTING AND RELATED METHODS

(71) Applicant: Netflix, Inc., Los Gatos, CA (US)

(72) Inventor: Paul Debevec, Culver City, CA (US)

(21) Appl. No.: 19/416,619

(22) Filed: Dec. 11, 2025

Related U.S. Application Data
(60) Provisional application No. 63/761,414, filed on Feb. 21, 2025.
(60) Provisional application No. 63/758,869, filed on Feb. 14, 2025.

(51) Int. Cl. G03B 15/07; G03B 15/05; H04N 23/56; H04N 25/532

(52) U.S. Cl. CPC G03B 15/07; G03B 15/05; H04N 23/56; H04N 25/532

(57) ABSTRACT

A lighting system includes at least a first light source and a second light source. The system also includes a camera system configured to capture sequential video frames under multiple lighting conditions. The system includes a synchronization system that is configured to activate the first light source during the last millisecond of a first frame and the second light source during the first millisecond of a subsequent frame. Applications include modern cinematography workflows requiring efficient lighting design and superior scene capture under varying illumination. Various other methods, systems, and computer-readable media are also disclosed.

### CROSS REFERENCE TO RELATED APPLICATION

This application claims the benefit of U.S. Provisional Application No. 63/761,414, filed 21 February 2025, the contents of which are incorporated, in their entirety, by this reference.

### BACKGROUND

Many contemporary cinematography applications now demand versatile and efficient lighting capture techniques to achieve desired visual aesthetics. In such productions, lighting design is typically executed by arranging and adjusting multiple light sources, such as LED arrays or spot fixtures, to sculpt actor appearances and environmental features. Because dynamic performances and last-minute creative changes are commonplace on modern sets, these manual lighting operations can become labor intensive, time consuming, and inflexible.

Conventional on-set workflows can involve capturing a sequence of differing illumination states by alternating light patterns at high frame rates. However, these approaches frequently require specialized high-speed cameras that compromise image quality and increase overall equipment costs. Alternative strategies employ optical flow or motion compensation algorithms to spatially align frames taken under varying lighting, but substantial differences between lighting states complicate motion estimation and can produce alignment artifacts. Existing solutions can also struggle to maintain flicker-free conditions for performers.

The present disclosure identifies and addresses a need for streamlined video capture methods and systems that enable near simultaneous acquisition of multiple lighting conditions with reduced motion artifacts, enhanced image fidelity, and integration into existing cinematography practices.

### SUMMARY

In some aspects, the techniques described herein relate to a system for lighting in video production, including a lighting system including at least a first light source and a second light source. The first light source and the second light source are capable of being selectively turned on for a duration of one millisecond or less. The system includes a camera system for capturing video in sequential frames including a first frame and a second frame temporally adjacent to and after the first frame. The system includes a synchronization system that synchronizes the first light source to activate during a last millisecond of the first frame and the second light source to activate during a first millisecond of the second frame. The first light source and the second light source are both deactivated during remaining times of the first frame and of the second frame.

In some embodiments, each of the first light source and the second light source includes a computer-controlled light-emitting diode (LED) light source. In some examples, the sequential frames further include a zeroth frame temporally adjacent to and before the first frame and a third frame temporally adjacent to and after the second frame. In some examples, the synchronization system further activates both the first light source and the second light source during the zeroth frame and both the first light source and the second light source during the third frame.

In some embodiments, during operation, each of the first light source and the second light source repeats activation at 72 flashes per second and the sequential frames have a frame rate of 96 frames per second. In some embodiments, the system further includes a motion compensation system configured to estimate and compensate for optical flow between activation of the first light source during the first frame and activation of the second light source during the second frame. In some examples, the motion compensation system estimates the optical flow by: (i) combining the first frame and the second frame to obtain a combined frame; (ii) computing a first optical flow between the zeroth frame and the combined frame; (iii) computing a second optical flow between the combined frame and the third frame; (iv) averaging the first optical flow and the second optical flow to obtain a flow vector; and (v) dividing the flow vector by 1000/72 to obtain an estimated flow vector between activation of the first light source and activation of the second light source.

In additional embodiments, during operation, each of the first light source and the second light source repeats activation at 72 flashes per second and the sequential frames have a frame rate of 144 frames per second. In some examples, the camera system includes a global shutter camera that, during operation, exposes all pixels of an image detector simultaneously. In some examples, the camera system includes a global 360° shutter camera that, during operation, exhibits an exposure time equal to a frame duration of each frame of the sequential frames. In some embodiments, the first light source illuminates a camera-side of a subject and the second light source illuminates a background behind the subject substantially without illuminating the camera-side of the subject to obtain a silhouette of the subject during the second frame.

In some embodiments, the first light source is configured to emit a first colored light and the second light source is configured to emit a second, different colored light. In some examples, the system further includes a surface normal estimation system configured to evaluate the first frame illuminated by the first light source and the second frame illuminated by the second light source and to estimate surface normals of a subject within the frames.

In some aspects, the techniques described herein relate to a method for lighting in video production, the method including: capturing a sequence of video frames of a scene using a global shutter camera; emitting a first light pulse from one or more computer-controlled light sources, the first light pulse having a pulse duration of one millisecond or less and occurring at a terminal portion of a first frame exposure; and emitting a second light pulse from the one or more computer-controlled light sources, the second light pulse having a pulse duration of one millisecond or less and occurring at an initial portion of a second frame exposure immediately following the first frame exposure, the first and second light pulses being synchronized to occur within one millisecond of each other.

In some embodiments, the method further includes repeating each of the first and second light pulses at a rate of at least 60 Hz. In some embodiments, capturing the sequence of video frames includes operating the global shutter camera at a frame rate of at least 96 frames per second. In some examples, the method further includes: computing an optical flow between the first light pulse in the first frame and the second light pulse in the second frame and modifying image data of the second frame according to the computed optical flow to align pixels of the second frame with pixels of the first frame.

In some aspects, the techniques described herein relate to a method for forming a system for video production, including: operatively coupling, to a light driver, at least one first light source and at least one second light source; operatively coupling, to the light driver, a global shutter camera for capturing video in frame sequences each including a first frame and a second frame; and synchronizing the global shutter camera and the light driver to cause the first light source to emit a first light pulse during a last millisecond of the first frame of each frame sequence and to cause the second light source to emit a second light pulse during a first millisecond of the second frame of each frame sequence.

In some embodiments, operatively coupling the light driver to the at least one first light source includes operatively coupling the light driver to a first plurality of light-emitting diode (LED) light sources and operatively coupling the light driver to the at least one second light source includes operatively coupling the light driver to a second plurality of LED light sources. In some examples, the method further includes positioning the first light source to be directed to illuminate a camera-side of a subject and positioning the second light source to be directed to illuminate a background behind the subject substantially without illuminating the camera-side of the subject.

Features from any of the embodiments described herein can be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a flow diagram of an example method for lighting in video production, according to at least one embodiment of the present disclosure.

FIG. 2 is a block diagram of a system for lighting in video production, according to at least one embodiment of the present disclosure.

FIG. 3 is a diagram of a set for lighting in video production, according to at least one embodiment of the present disclosure.

FIG. 4 is a diagram of the set of FIG. 3 in operation, according to at least one embodiment of the present disclosure.

FIG. 5 is a timeline that illustrates synchronization of lighting and video frames, according to at least one embodiment of the present disclosure.

FIG. 6 is a timeline that illustrates synchronization of lighting and video frames, according to at least one additional embodiment of the present disclosure.

FIG. 7 is a timeline that illustrates optical flow during a sequence of video frames, according to at least one embodiment of the present disclosure.

FIG. 8 is a diagram illustrating a matted video frame and a corrected matted video frame, according to at least one embodiment of the present disclosure.

FIG. 9 shows a sequence of four video frames obtained according to at least one embodiment of the present disclosure.

FIG. 10 shows a sequence of two captured video frames and a combined video frame that reduces spectral reflections, according to at least one embodiment of the present disclosure.

FIG. 11 is a diagram of a set including a video production system according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure generally relates to systems for video production lighting and related methods. More specifically, the described technology addresses techniques for capturing live-action scenes under multiple (e.g., two) near-simultaneous lighting conditions, enabling advanced post-production capabilities such as relighting, matting, and reflection suppression. The disclosed systems and methods are particularly suited for modern cinematography workflows, where efficiency, flexibility, and achieving high-quality visual results are important.

Many contemporary cinematography techniques face significant challenges in capturing high-quality live-action scenes under multiple lighting conditions. Traditional methods often rely on high-speed cameras to alternate between various lighting states, enabling post-production relighting and other advanced visual effects. However, these approaches are hindered by several limitations. High-speed cameras, while capable of capturing rapid lighting changes, often suffer from reduced image quality due to lower resolution and poor signal-to-noise ratios. Additionally, these cameras are expensive, making them impractical for widespread use. Another significant issue is the introduction of motion artifacts when actors or objects move during the capture of successive lighting conditions. Optical flow and motion compensation algorithms have been employed to address these artifacts, but the substantial differences between lighting states complicate motion estimation, leading to alignment errors and visual artifacts. Furthermore, existing techniques often fail to maintain flicker-free conditions for performers.

The present disclosure addresses these limitations by introducing a lighting technique that enables the near-simultaneous capture of two distinct lighting conditions using a global or high-speed shutter cinema camera synchronized with high-speed, computer-controlled lighting (e.g., LED lighting). Unlike prior methods that require capturing numerous lighting conditions at extremely high frame rates, the disclosed system alternates between just two lighting states at a high frequency, ensuring that the time interval between lighting conditions is reduced to less than five milliseconds, such as one millisecond or less. This approach reduces motion artifacts and enhances image quality by leveraging modern global shutter cameras, which expose all pixels simultaneously, and by employing brief, precisely timed lighting flashes (e.g., having a duration of five milliseconds or less, such as one millisecond per flash). The system also operates at a frequency (e.g., 72 Hz) above a human flicker fusion frequency (e.g., about 60 Hz), ensuring a comfortable and flicker-free environment for performers.

The disclosed concepts can further incorporate advanced optical flow techniques to compensate for any residual motion between the two lighting conditions. By analyzing the sum of consecutive frames and leveraging the temporal alignment facilitated by the disclosed process, the system generates accurate motion vectors to align images with reduced computational overhead. This alignment enables a range of post-production capabilities, including relighting, high-quality matting, surface orientation extraction, and reflection suppression. Additionally, the paired lighting conditions can be used to generate training data for machine learning models, enabling the development of algorithms that can transform appearances under different lighting states. The disclosed system thus provides a streamlined, cost-effective, and high-fidelity solution for modern cinematography workflows, addressing certain inefficiencies and technical challenges of prior approaches while unlocking new creative possibilities.

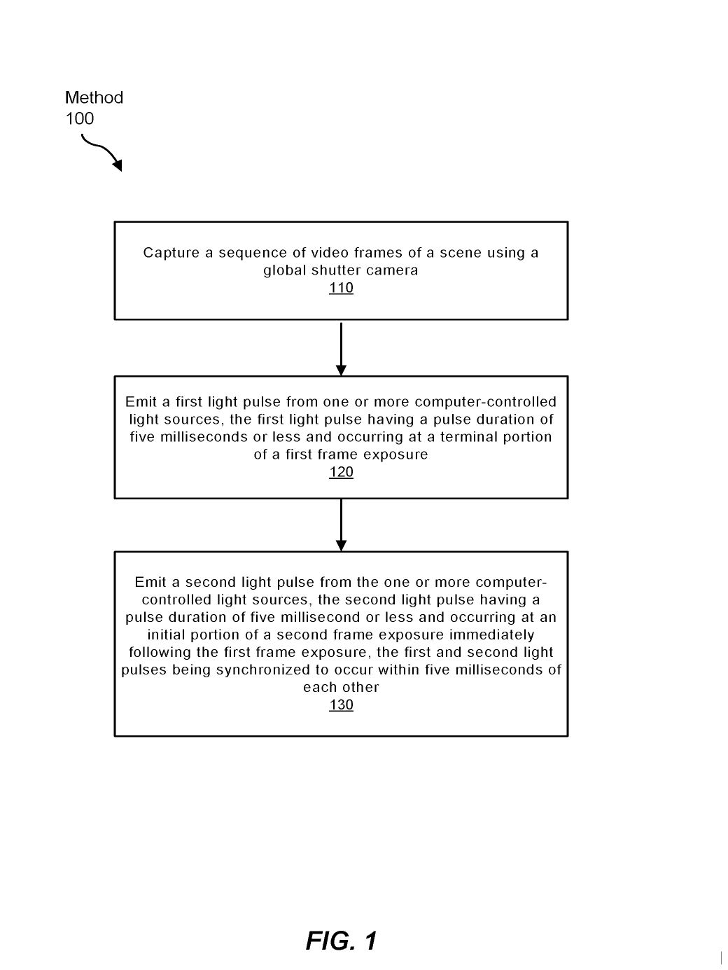

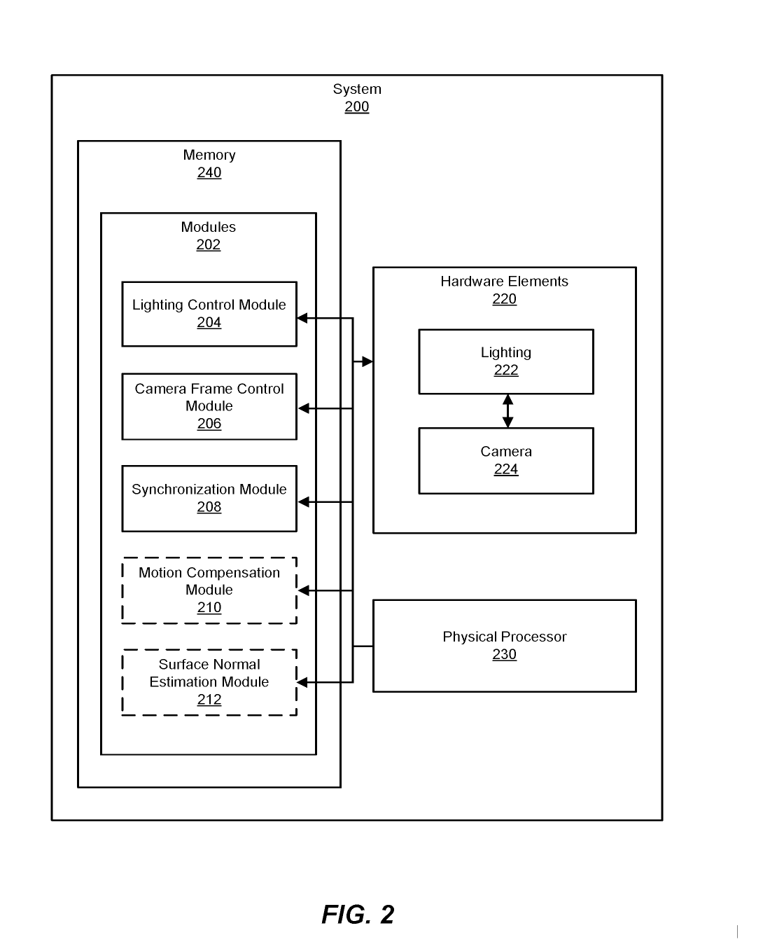

FIG. 1 is a flow diagram of an example computer-implemented method 100 for lighting in video production, according to at least one embodiment of the present disclosure. The steps shown in FIG. 1 are performed by any suitable computer-executable code and/or computing system, including system 200 illustrated in FIG. 2. In one example, each of the steps of method 100 shown in FIG. 1 represent a process whose structure includes and/or is represented by multiple sub-steps, examples of which will be provided in greater detail below.

As illustrated in FIG. 2, system 200 includes a memory 240 that stores a plurality of modules 202, including lighting control module 204, a camera frame control module 206, and a synchronization module 208. Optionally, in some embodiments, modules 202 also include a motion compensation module 210 and/or a surface normal estimation module 212. System 200 further includes a physical processor 230 configured to execute instructions associated with these modules 202.

Hardware elements 220 of system 200 include lighting 222 and a camera 224. Lighting 222 includes at least two different light sources, which can each be a single light or multiple lights positioned and configured to illuminate a subject and/or a scene to be captured by camera 224. In some embodiments, camera 224 is a global shutter camera that exposes all image sensor pixels simultaneously (e.g., as opposed to a rolling shutter camera that exposes the image sensor pixels sequentially, such as row-by-row). Alternatively or additionally, in some embodiments camera 224 is a 360° shutter camera that exposes the image sensor pixels for an entire frame exposure duration. Lighting control module 204 controls activation of lighting 222 and camera frame control module 206 controls aspects of camera 224, such as a frame rate. Synchronization module 208, in connection with lighting control module 204 and camera frame control module 206, synchronizes timing of activation of lighting 222 and video frames captured by camera 224, as will be explained further below.

As illustrated in FIG. 1, at step 110, system 200 described herein captures a sequence of video frames of a scene using a global shutter camera 224. System 200 described herein can perform step 110 in a variety of ways. For example, camera 224 of system 200 can be a global shutter camera that exposes all image sensor pixels simultaneously during each frame to reduce temporal distortion and motion artifacts that can otherwise occur with rolling shutter cameras. In some examples, camera 224 can also be operated as a 360° shutter camera that exposes the image sensor pixels during an entire frame duration.

At step 120, system 200 described herein emits a first light pulse from one or more computer-controlled light sources (e.g., one or more light sources of lighting 222). The first light pulse has a pulse duration of five milliseconds or less (e.g., about one millisecond) and is timed to occur at a terminal portion of a first frame exposure of the sequence of video frames (e.g., a last five milliseconds, a last millisecond, etc.). System 200 described herein can perform step 120 in a variety of ways. For example, synchronization module 208, in connection with lighting control module 204 and/or camera control module 206, can precisely trigger the activation of the first light source during the final five milliseconds or during the final one millisecond of the first frame exposure. In some examples, neither the first light source nor any other light sources are activated during the remainder of the first frame exposure, such that the first frame exposure captures the scene substantially only based on illumination by the first light source during the first light pulse.

In certain embodiments, the first light source includes a computer-controlled light-emitting diode (LED) light or array of lights capable of rapid on-off switching, allowing for accurate timing and low latency. In some examples, the first light pulse duration is reduced to one millisecond or less and is synchronized to the last millisecond of the first frame exposure.

At step 130, system 200 described herein emits a second light pulse from one or more computer-controlled light sources. The second light pulse has a pulse duration of five milliseconds or less and is timed to occur at an initial portion of a second frame exposure immediately after the first frame exposure. System 200 described herein can perform step 130 in a variety of ways. For example, synchronization module, in connection with lighting control module 204 and/or camera control module 206, can precisely trigger the activation of the second light source during the initial five milliseconds or during the initial one millisecond of the second frame exposure. In some examples, neither the second light source nor any other light sources are activated during the remainder of the second frame exposure, such that the second frame exposure captures the scene substantially only based on illumination by the second light source during the second light pulse.

In certain embodiments, the second light source includes a computer-controlled LED light or array of lights capable of rapid on-off switching, allowing for accurate timing and low latency. The second light source is different than the first light source, such as in position, color, light intensity, angle, number of lights, etc. In some examples, the second light pulse duration is reduced to one millisecond or less and is synchronized to the first millisecond of the second frame exposure to reduce subject motion between the first lighting condition and second lighting condition and to enhance the fidelity of the captured image.

In some examples, system 200 can adjust the intensity, color, and/or spatial distribution of the emitted light pulses based on a desired visual effect and/or post-production requirements. By coordinating the timing and characteristics of the first light pulse and second light pulse with the camera’s exposure cycle, system 200 enables the acquisition of sequential video frames under controlled variable and repeatable lighting conditions, facilitating advanced image processing and creative workflows. By synchronizing the first light pulse to the last moment of the first video frame and the second light pulse to the first moment of the second video frame, very little or no subject motion occurs between the two captured video frames, causing them to be substantially equal but under different lighting conditions. In some embodiments, motion or position differences between the two captured video frames are compensated for, such as by motion compensation module 210.

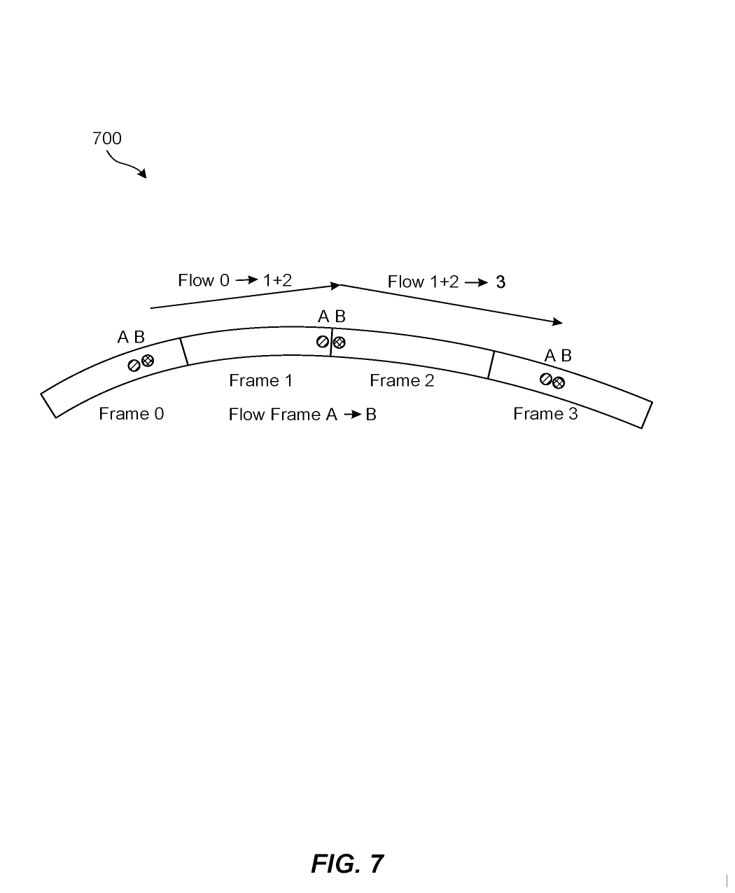

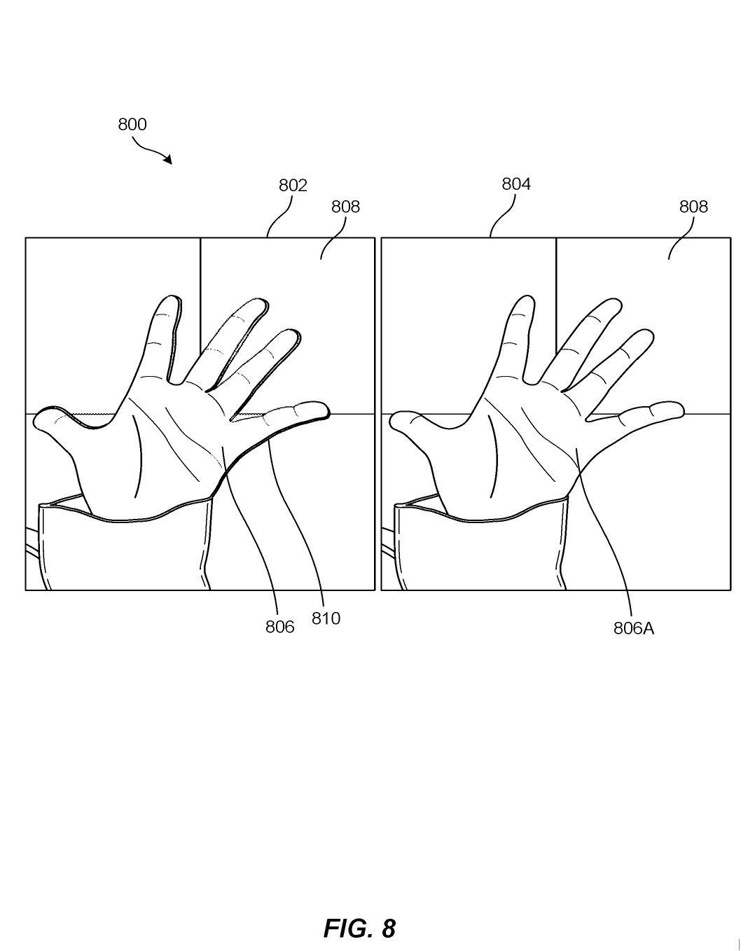

Motion compensation module 210 is configured to estimate and correct motion artifacts that occur between sequential video frames captured under different lighting conditions. Motion compensation module 210 utilizes advanced optical flow algorithms to analyze the motion of objects or subjects within the scene by calculating motion vectors between frames. Specifically, motion compensation module 210 determines the optical flow between a composite frame, which combines two consecutive frames with distinct lighting conditions, and adjacent frames that capture the sum of these lighting conditions. The flow vectors represent movement of pixels between the video frames. By averaging the flow vectors from both preceding and succeeding frames, motion compensation module 210 generates an estimate of the motion between the two lighting conditions. The calculated motion vectors are then used to align the frames, compensating for any residual subject movement occurring during the brief interval (e.g., five milliseconds, one millisecond, etc.) between lighting states. This alignment results in high-quality image fidelity, enabling post-production processes such as relighting, matting, and reflection suppression. Example implementations of motion compensation module 210 are described below with respect to FIGS. 7 and 8.

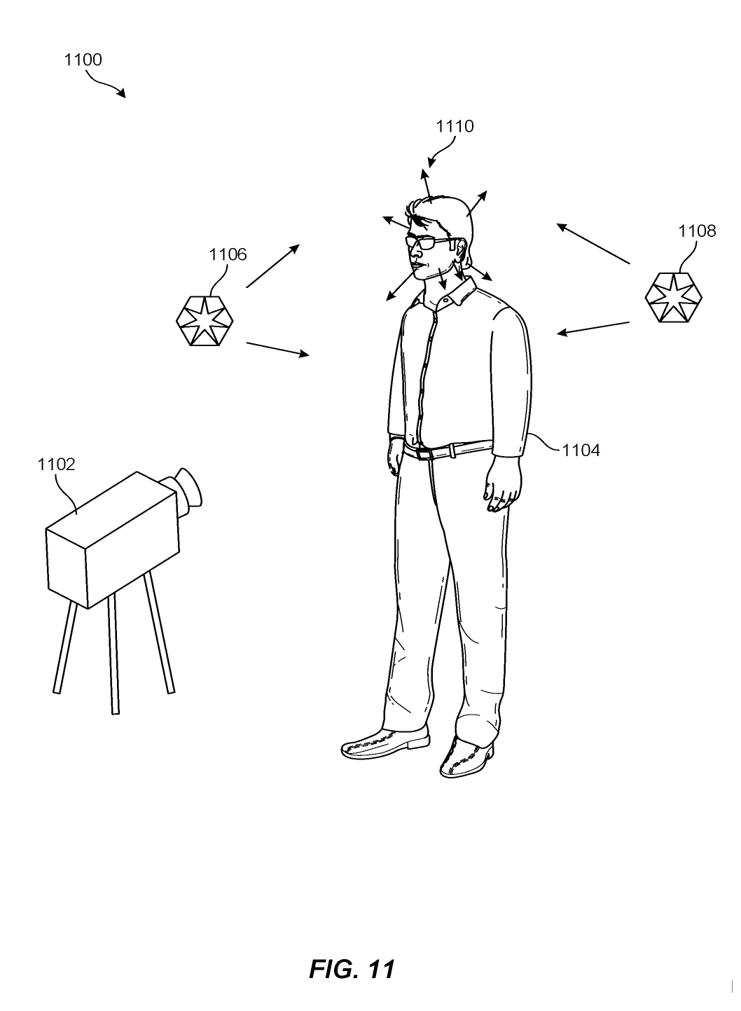

Surface normal estimation module 212 is configured to analyze captured video frames illuminated under distinct lighting conditions to determine the orientation of surfaces within a scene. Surface normal estimation module 212 utilizes photometric stereo techniques, which involve comparing the intensity variations of pixels across frames captured under different lighting states. By leveraging the synchronized lighting pulses and global shutter camera exposures, surface normal estimation module 212 calculates surface orientations with high precision, even in dynamic environments. Surface normal estimation module 212 processes the difference between frames illuminated by two distinct lighting conditions, such as different colored lights, dividing the difference by the sum of the conditions to estimate the photometric surface normals (e.g., orientations). These surface normals provide valuable insights about the geometry and reflectance properties of objects, enabling advanced post-production capabilities such as relighting, texture mapping, and realistic rendering of three-dimensional subjects, objects, and scenes. Example implementations of motion compensation module 210 are described below with respect to FIG. 11.

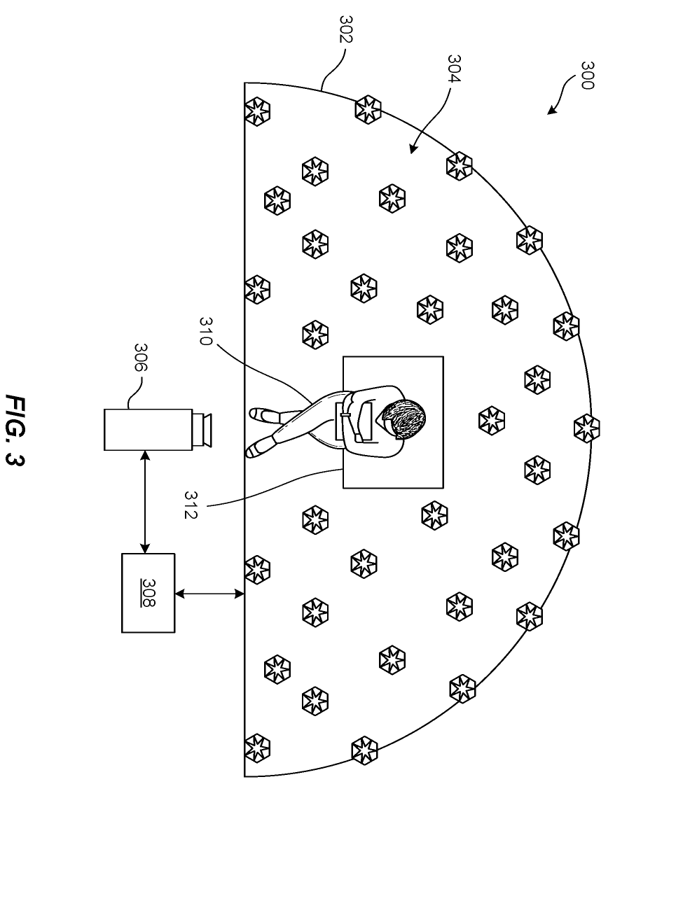

FIG. 3 is a diagram of a set 300 for lighting in video production, according to at least one embodiment of the present disclosure.

In some embodiments, set 300 can represent an environment configured for filming an actor under controlled lighting conditions and embodies an example framework for implementing techniques of the present disclosure. Accordingly, set 300 enables the capture of video frames under two near-simultaneous lighting conditions. In some examples, set 300 includes a lighting assembly 302, a plurality of light sources 304 in the lighting assembly 302, a camera 306, and a synchronization system 308. Set 300 is configured for capturing video of a subject 310 and/or a background 312 under multiple lighting conditions. These components cooperate to achieve precise synchronization between lighting and video capture, to provide high-quality results for applications such as relighting, matting, and reflection suppression.

In some embodiments, lighting assembly 302 can serve as a structural framework that houses and supports plurality of light sources 304. For example, lighting assembly 302 can be configured in various shapes such as a dome to provide uniform and controlled illumination across set 300 and to accommodate different filming scenarios. For example, light sources 304 can be positioned on all sides of the subject 310, including in front, behind, to the left side, to the right side, on top of, beneath, and/or any combination thereof. Moreover, lighting assembly 302 is in communication with synchronization system 308, either wirelessly or through a wired connection, to coordinate the precise timing and duration of light pulses in conjunction with operation of camera 306. As a result, lighting assembly 302 works together with other components to enable the rapid alternation of lighting conditions required for capturing near-simultaneous frames under distinct lighting states.

In some examples, light sources 304 are integrated into lighting assembly 302 and are responsible for selectively illuminating subject 310 and/or background 312. Each light source 304 can be a computer-controlled light-emitting diode (LED) or an array of LEDs capable of rapid on-off switching. The light sources 304 are configured to emit light pulses with durations as short as one millisecond or less, thereby allowing precise control over lighting conditions. Furthermore, light sources 304 are in communication with synchronization system 308, which coordinates their activation with frame capture by camera 306. In some configurations, light sources 304 include only two respective lights or arrays of lights, enabling the production of video with two distinct lighting conditions. Light sources 304 can be adjusted and/or selected to emit varying intensities, colors, and spatial distributions depending on the desired visual effect or post-production requirements.

In some embodiments, camera 306 can be positioned within set 300 to capture video frames of subject 310 under the controlled lighting conditions provided by lighting assembly 302. For example, camera 306 can include a global shutter camera that exposes all image sensor pixels simultaneously to reduce temporal distortion and motion artifacts. Alternatively or additionally, camera 306 can include a 360° shutter camera which exposes image sensor pixels for the entire frame duration. Camera 306 is in communication with synchronization system 308, either wirelessly or through a wired connection, to ensure that timing of frame capture is precisely aligned with activation of light sources 304. This synchronization enables camera 306 to capture sequential frames under two distinct lighting conditions with minimal motion artifacts.

Accordingly, synchronization system 308 is responsible for coordinating the operation of lighting assembly 302 and camera 306. Specifically, synchronization system 308 triggers a first light source 304 to emit a light pulse during the last millisecond of one frame and triggers a second light source 304 to emit a light pulse during the first millisecond of the subsequent frame. This precise timing reduces motion artifacts between the two lighting conditions and enables capture of high-quality video frames for advanced post-production applications. Synchronization system 308 can communicate with lighting assembly 302 and camera 306 either wirelessly or through wired connections.

Although synchronization system 308 is illustrated in FIG. 3 as a distinct element from light sources 304 and from camera 306, the present disclosure is not so limited. For example, in additional embodiments, synchronization system 308 can be integrated into camera 306 and/or into light sources 304.

In some examples, subject 310 represents the primary focus of the filming process within set 300 and can include an actor (as shown in FIG. 3), an object, or any other entity intended to be captured under the controlled lighting conditions provided by lighting assembly 302. Subject 310 is illuminated by plurality of light sources 304, which are synchronized with camera 306 to capture video frames under two distinct lighting conditions. Subject 310 can be stationary or in motion. The disclosed techniques reduce artifacts, thereby ensuring that captured frames are suitable for applications such as relighting, matting, and reflection suppression.

In some embodiments, background 312 can serve as an optional component of set 300 and can be illuminated by light sources 304 to achieve specific visual effects. For example, one lighting condition can illuminate subject 310 against a dark background 312, whereas another lighting condition silhouettes subject 310 against an illuminated background 312 for matting applications. Background 312 can be configured to support various lighting scenarios depending on requirements of the filming process. The interaction between background 312, subject 310, and lighting assembly 302 can be carefully controlled to reach desired results for post-production workflows.

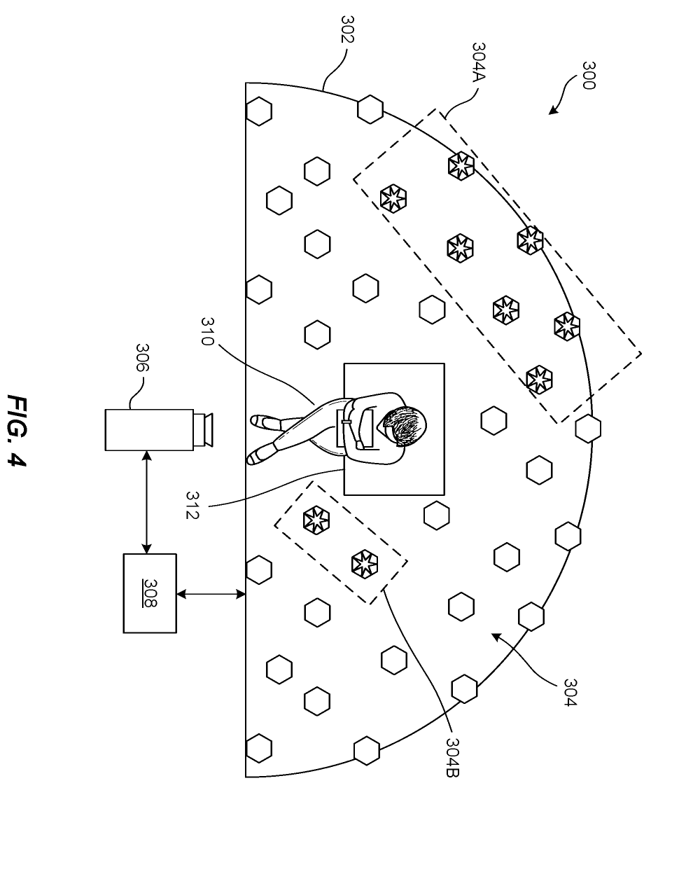

FIG. 4 is a diagram of the set 300 of FIG. 3 in operation, according to at least one embodiment of the present disclosure.

FIG. 4 illustrates an example operation in which a first light source 304A and second light source 304B are respective subsets of light sources 304. First light source 304A and second light source 304B provide two distinct lighting conditions that are synchronized with synchronization system 308 to align activation with frame capture by camera 306.

By way of example and not limitation, in the embodiment illustrated in FIG. 4, first light source 304A is positioned to illuminate subject 310 and/or background 312 from a specific angle, such as the camera-facing side, thereby creating a primary lighting effect. In some embodiments, first light source 304A emits light of a particular color, which can be used in conjunction with second light source 304B to facilitate surface normal estimation. First light source 304A is capable of rapid on-off switching and is synchronized with camera 306 via synchronization system 308 to emit a first light pulse at a precise interval, such as at a terminal portion of a first frame captured by camera 306.

Similarly, second light source 304B is positioned to illuminate subject 310 and/or background 312 from a different angle than first light source 304A. For example, second light source 304B can illuminate background 312 while avoiding the camera-facing side of subject 310, thereby creating a silhouette effect that facilitates matting. In additional embodiments, second light source 304B emits light of a different color than first light source 304A, enabling surface normal estimation by comparing intensity variations between the two lighting conditions. Like first light source 304A, second light source 304B is capable of rapid on-off switching and is synchronized with camera 306 via synchronization system 308, such as to emit a second light pulse at an initial portion of a second frame captured by camera 306 momentarily after the first light pulse.

In some embodiments, synchronization system 308 causes first light source 304A to emit a light pulse during the last millisecond of one frame and causes second light source 304B to emit a light pulse during the first millisecond of the subsequent frame. This precise timing reduces motion artifacts between the two lighting conditions and enables capture of high-quality video frames for advanced post-production applications such as relighting, matting, and surface normal estimation.

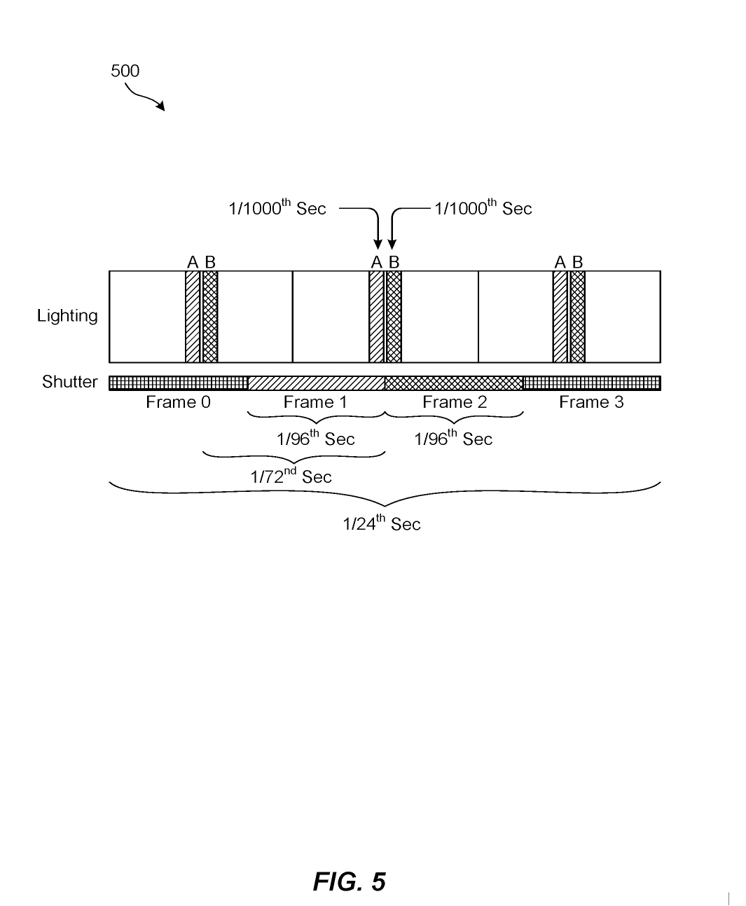

FIG. 5 is a timeline 500 that illustrates synchronization of lighting and video frames, according to at least one embodiment of the present disclosure.

In some embodiments, a camera (e.g., a global shutter camera) is operated at a frame rate of 96 frames per second (fps) and corresponding lighting is operated at a light pulse frequency of 72 Hz for each of lighting condition A and lighting condition B. In this example, timeline 500 is divided into sequential frames: a zeroth frame (labeled Frame 0), a first frame (labeled Frame 1), a second frame (labeled Frame 2), and a third frame (labeled Frame 3). These frames collectively form one sequence of video frames and lighting conditions that is repeated many times during a video capture session.

In the example of FIG. 5, each frame has a duration of 1/96 seconds, corresponding to the 96 fps frame rate of the global shutter camera. Additionally, timeline 500 highlights the precise timing of light pulses and their synchronization with the camera shutter. For each frame, the global shutter camera exposes all pixels simultaneously to ensure that the captured frames are free from temporal distortion and rolling shutter artifacts. Aligning the light pulses with the shutter achieves the intended lighting effects and reducing motion artifacts.

Lighting conditions A and B are represented as distinct light pulses, each having a duration of five milliseconds or less, such as about one millisecond (e.g., 1/1000 second). These light pulses are alternated in a specific sequence to achieve the techniques described in the present disclosure. For example, timeline 500 demonstrates how lighting condition A is applied at a final millisecond of Frame 1 and lighting condition B is applied at an initial millisecond of Frame 2.

Optionally, in some embodiments, Frame 0 and Frame 3 are each illuminated by both lighting conditions A and B, while Frame 1 is illuminated only by lighting condition A and Frame 2 is illuminated only by lighting condition B. In this configuration, the combined frames (Frame 0 and Frame 3) can be used to estimate optical flow for motion compensation, such as by using motion compensation module 210, as described in the present disclosure. Alternatively, these combined frames can be omitted from memory (e.g., memory 24) if only the non-combined lighting conditions A and or B are desired.

Furthermore, timeline 500 illustrates that the interval between consecutive frames is 1/96 seconds, while the interval between consecutive light pulses of lighting condition A or B is 1/72 seconds. This configuration results in a light pulse frequency (e.g., 72 Hz) that is above the human flicker fusion threshold (e.g., about 60 Hz), providing a comfortable and substantially flicker-free environment for performers. The short duration of the light pulses (e.g., five milliseconds, one millisecond, etc.) reduces motion between lighting conditions, which further enhances the quality of the captured video frames. Movement of a subject, object, or background between the lighting conditions can be compensated for in post-production, such as by optical flow estimation and motion compensation as described herein.

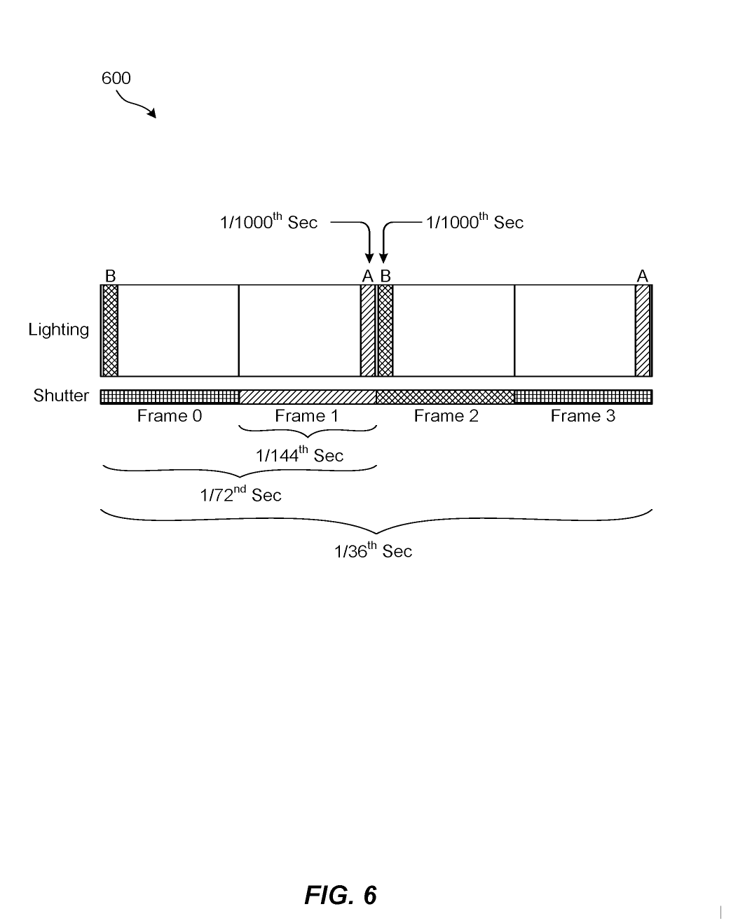

FIG. 6 is a timeline 600 that illustrates synchronization of lighting and video frames, according to at least one additional embodiment of the present disclosure.

Timeline 600 is divided into sequential frames including a zeroth frame (Frame 0), a first frame (Frame 1), a second frame (Frame 2), and a third frame (Frame 3), which collectively represent a series of video exposures. The lighting conditions, labeled as A and B, are activated with precise timing to occur within specific intervals during each frame exposure.

For example, timeline 600 shows that lighting condition A is activated during the last millisecond of Frame 1 and the last millisecond of Frame 3, while lighting condition B is activated during the first millisecond of Frame 0 and the first millisecond of Frame 2. In some embodiments, this alternating pattern enables each frame to be captured under distinct illumination, thereby facilitating advanced post-production capabilities such as relighting and motion compensation. The synchronization between the lighting pulses and camera shutter exposures reduces motion artifacts and enhances image fidelity.

In the example illustrated in FIG. 6, the duration of each frame is 1/144th of a second, corresponding to a frame rate of 144 frames per second. The lighting pulses alternate at a frequency of 72 Hz, with each pulse lasting 1/1,000th of a second. This configuration is designed to ensure that the light pulse frequency surpasses the human flicker-fusion threshold, providing a comfortable, flicker-free environment for performers. Additionally, the short duration of the light pulses minimizes subject motion between lighting conditions, thereby facilitating integration into cinematography workflows and enhancing overall capture accuracy.

Unlike the configuration in timeline 500, timeline 600 is designed to capture frames illuminated by either lighting condition A or lighting condition B, while omitting frames that combine both lighting conditions. This setup operates at a higher frame rate of 144 frames per second (fps), allowing for alternating frames under distinct lighting conditions while reducing motion artifacts and enhancing image fidelity. The increased frame rate of 144 fps strikes a balance between maintaining high-quality visual results, reducing equipment costs, and achieving precise temporal alignment of lighting conditions, making this approach suitable for advanced cinematography workflows.

FIG. 5 illustrates an example scenario in which the frame rate is 96 frames per second and the light pulse frequency is 72 flashes per second, while FIG. 6 illustrates another example scenario in which the frame rate is 144 frames per second and the light pulse frequency is 72 flashes per second. These frequencies are presented by way of example for certain embodiments of the present disclosure. In additional embodiments, other frame rates and/or light pulse frequencies are possible in which the two lighting conditions are respectively present at an end of one frame and at a beginning of a next frame. For example, light pulse frequencies of each lighting condition can be between about 60 Hz and about 100 Hz, such as 64-90 Hz, 70-80 Hz, 72-75 Hz, etc., and frame rates can be between about 120 frames per second and about 200 frames per second, such as 128-180 fps, 140-160 fps, 144-150 fps, etc. Depending on technical needs, equipment availability, cost, etc., other light pulse frequencies and/or frame rates are also possible.

FIG. 7 is a timeline 700 that illustrates optical flow during a sequence of video frames, according to at least one embodiment of the present disclosure.

In this example, timeline 700 demonstrates the interaction and transition between frames illuminated under distinct lighting conditions, labeled as A and B, and the corresponding flow of information between these frames, in a situation similar to that shown in FIG. 5.

For example, timeline 700 includes a sequence of frames, specifically a zeroth frame (Frame 0), first frame (Frame 1), second frame (Frame 2), and third frame (Frame 3). Frame 0 and Frame 3 are illuminated by both lighting conditions A and B, while Frame 1 and Frame 2 are illuminated solely by lighting condition A and lighting condition B, respectively. In timeline 700, the transitions between these frames are represented by optical flow vectors, which indicate the optical flow calculations performed to align and process the frames, such as for motion compensation between lighting condition A in frame 1 and lighting condition B in frame 2.

Initially, to perform the optical flow calculations and to obtain similar lighting conditions, frames 1 and 2 are combined to result in a combined frame 1+2 that depicts the sum of lighting conditions A and B from frames 1 and 2. Thus, the combined frame 1+2 has the same lighting condition as frame 0 and as frame 3 to facilitate optical flow calculations. The optical flow from Frame 0 to the combined Frame 1+2 and the optical flow from the combined Frame 1+2 to Frame 3 are calculated. These optical flows represent movements of pixels between frame 0 and combined frame 1+2 and between combined frame 1+2 and frame 3 to estimate how the pixels in each frame move overtime.

These two optical flows are then averaged to generate an average motion vector that accounts for subject movement across the sequence. To estimate the optical flow specifically between frame 1 (lighting condition A) and frame 2 (lighting condition B), the average optical flow is scaled by a fraction corresponding to the temporal interval between the two lighting conditions. For example, in a scenario where lighting conditions A and B are separated by one millisecond and repeated at 72 Hz, the average flow is divided by 1000/72 to result in an estimated optical flow between the lighting condition A and the lighting condition B one millisecond later. This approach enables compensation for the estimated motion between the lighting conditions A and B and enables high-fidelity post-production processes such as relighting, matting, and reflection suppression.

FIG. 8 is a diagram 800 illustrating a matted video frame 802 and a corrected matted video frame 804, according to at least one embodiment of the present disclosure.

Diagram 800 illustrates the process and results of applying the disclosed techniques to a scene involving a hand 806 that is moving (e.g., waving) under two distinct lighting conditions. In some embodiments, the matted video frame 802 is obtained by merging two sequential frames captured under different lighting conditions. For example, the first frame is illuminated by a first light source directed at the camera-facing side of the hand 806, while the second frame is illuminated by a second light source that primarily lights the background 808. As a result, the second frame yields a matte 810, which visually isolates hand 806 from the background 808. However, due to the one millisecond interval between the frames, slight motion of the hand 806 causes misalignment between the hand and the corresponding matte 810, leading to visible artifacts in the combined frame as shown in matted video frame 802.

Corrected matted video frame 804 represents the output after motion compensation has been applied to the matted video frame 802. In this example, the motion compensation process aligns the hand 806 and the corresponding matte 810 by estimating (e.g., as discussed above with reference to FIG. 7) and correcting for the motion that occurred during the one millisecond interval between the two lighting conditions. For example, correction of the estimated motion can involve reformatting pixel positions to align the image of the hand 806 with the image of the matte 810. As a result, the corrected hand 806A in the corrected matted video frame 804 is properly aligned with the associated matte 810, thereby eliminating the artifacts observed in the matted video frame 802. This alignment produces a result of high quality, suitable for post-production applications such as relighting or compositing.

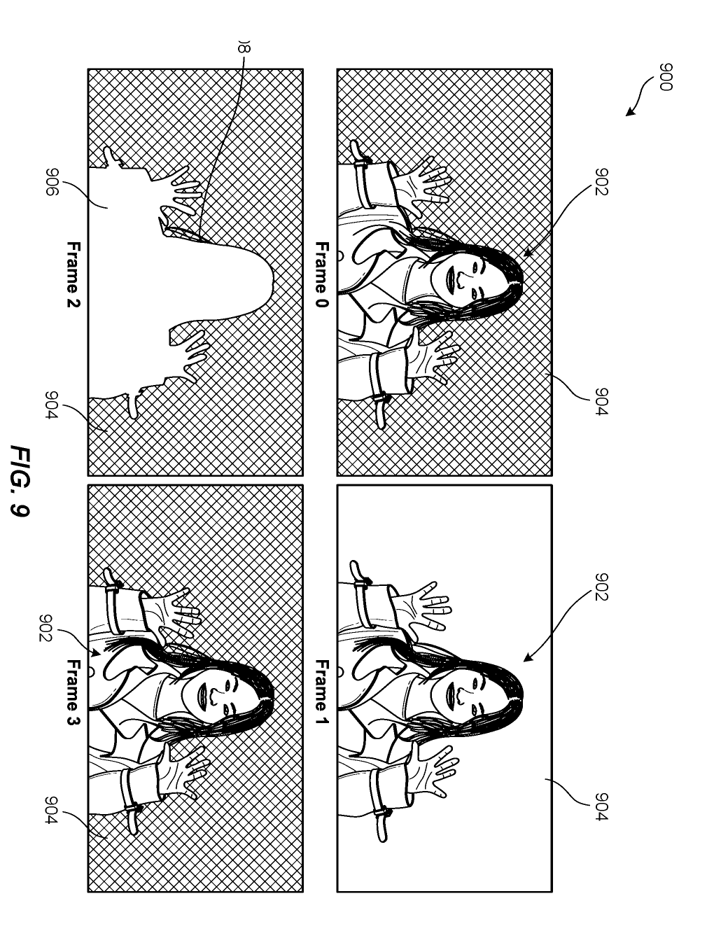

FIG. 9 shows a sequence 900 of four video frames obtained according to at least one embodiment of the present disclosure.

In some embodiments, sequence 900 corresponds to four video frames captured under alternating lighting conditions as described in the present disclosure. For example, Frame 0, Frame 1, Frame 2, and Frame 3 can be captured using a global shutter camera synchronized with computer-controlled lighting to alternate between two distinct lighting conditions. Frame 0 and Frame 3 are exposed with both lighting conditions simultaneously, while Frame 1 and Frame 2 are exposed under a first lighting condition and a second lighting condition, respectively.

In this example, in Frame 0, subject 902 is illuminated by both the first lighting condition (e.g., illuminating the camera-facing side) and the second lighting condition (e.g., illuminating the background 904). Next, in Frame 1, subject 902 is illuminated solely with the first lighting condition with no background illumination. Then, in Frame 2, the second lighting condition is applied (e.g., illuminating background 904 but not the camera-facing side of subject 902) to silhouette subject 902 against illuminated background 904. Frame 3 returns to the combined illumination of both lighting conditions, as in Frame 1. This differential illumination of background 904 plays a role in generating a high-quality matte 906 and enabling seamless background replacement in post-production.

Matte 906 can be derived from Frame 2 of sequence 900, where subject 902 is silhouetted against the illuminated background 904. Matte 906 isolates subject 902 from background 904, capturing fine details such as hair strands 908 and even partial transparency. This high-quality matte 906 can be used in advanced post-production techniques, such as compositing subject 902 onto a new background and/or applying relighting effects. The precision of matte 906 ensures that even intricate features of subject 902 are accurately represented, enabling smooth integration into various visual-effects workflows.

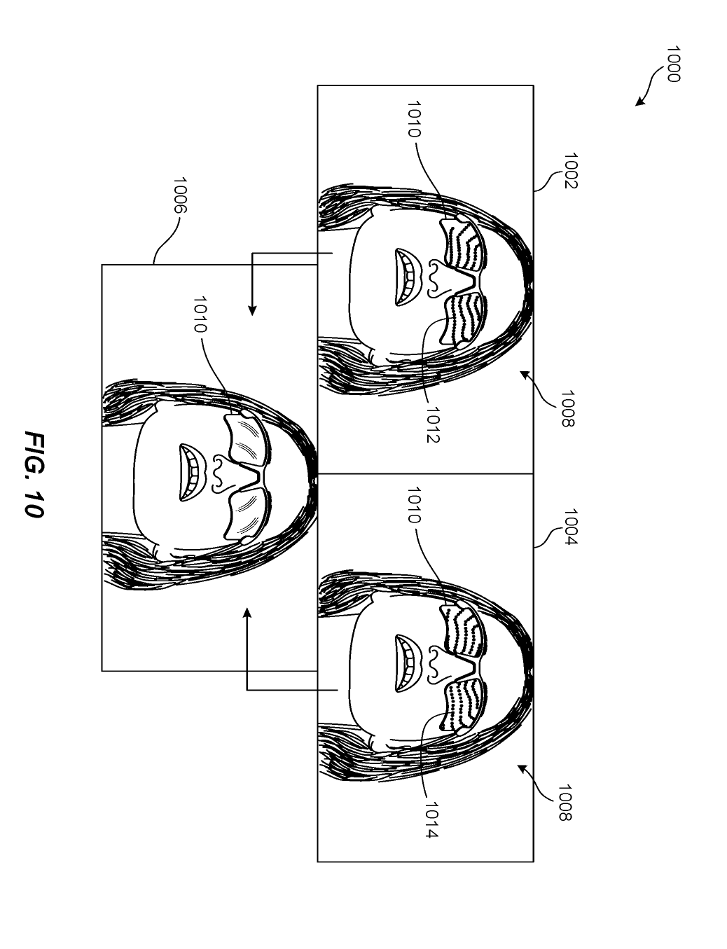

FIG. 10 shows a sequence 1000 of two captured video frames 1002, 1004 and a combined video frame 1006 that reduces spectral reflections, according to at least one embodiment of the present disclosure.

In some embodiments, sequence 1000 is designed to facilitate post-production processes, such as reflection suppression, by capturing frames under distinct illumination profiles and combining them to produce a final frame with enhanced visual quality.

In some embodiments, a first video frame 1002 is captured under the illumination of a first light source 1012. Specifically, this first video frame 1002 captures the subject 1008 and any spectral reflections caused by first light source 1012, such as those visible on glasses 1010 worn by subject 1008 or some other reflective surface. First video frame 1002 serves as one of two primary inputs for generating combined video frame 1006, which is subsequently processed to remove residual spectral artifacts.

In some embodiments, a second video frame 1004 is captured immediately following (e.g., within one millisecond after) first video frame 1002 and is illuminated by the second light source 1014. In this example, first light source 1012 and second light source 1014 are respectively alternating rows of lights that do not directly overlap. This second video frame 1004 likewise captures subject 1008 and any reflections produced by second light source 1014, including those observable in glasses 1010 or some other reflective surface. Second video frame 1004 provides the second primary input for generation of combined video frame 1006.

Combined video frame 1006 is generated by processing first video frame 1002 and second video frame 1004. Specifically, combined video frame 1006 is created by retaining the minimum common pixel values between the two frames. As a result, spectral reflections that do not overlap such as those present on glasses 1010 are substantially removed, leading to a refined image without such artifacts or with significantly reduced artifacts.

In some embodiments, subject 1008 is the primary focus of sequence 1000. The subject 1008 is illuminated alternately by first light source 1012 and second light source 1014, thereby enabling capture of distinct lighting conditions in first video frame 1002 and second video frame 1004.

FIG. 11 is a diagram of a set 1100 including a video production system according to at least one embodiment of the present disclosure.

In certain embodiments, set 1100 represents a controlled environment where the lighting and camera system functions to capture video frames of a subject 1104 under distinct and near-simultaneous lighting conditions. For instance, set 1100 is configured to enable precise synchronization of light sources 1106 and 1108 with global shutter camera 1102. Furthermore, set 1100 offers the spatial arrangement and structural support for the components, promoting proper alignment and operation. This configuration allows for the reliable capture of video frames required for post-production processes such as estimation of surface normals 1110, relighting, and 3D modeling.

In some embodiments, camera 1102 is capable of capturing high-resolution video frames at elevated frame rates, for example, 96 frames per second or 144 frames per second. The global shutter functionality enables simultaneous exposure of all pixels on the image sensor, thereby eliminating rolling shutter artifacts and reducing temporal distortion. Camera 1102 is synchronized with first light source 1106 and second light source 1108 to capture sequential frames under distinct lighting conditions, as described in the present disclosure. This synchronization allows camera 1102 to record frames with reduced motion artifacts between lighting conditions. The video frames captured are subsequently analyzed during post-production to derive surface normals 1110 and execute advanced visual effects.

In some embodiments, subject 1104 is the primary focus of the video capture process within set 1100 and can include an actor, an object, or any other entity intended to be captured under controlled lighting conditions. Subject 1104 is illuminated by first light source 1106 and second light source 1108, which emit distinct colored lights in a synchronized manner. Alternating lighting conditions enable capture of video frames that can be analyzed to estimate surface normals 1110 representing the orientation of surfaces of subject 1104. These surface normals 1110 can be used to create a detailed 3D digital representation of subject 1104, enabling post-production applications such as relighting, texture mapping, and realistic rendering.

In some embodiments, first light source 1106 includes a computer-controlled light-emitting diode (LED) or an array of LEDs capable of rapid on-off switching. First light source 1106 is configured to emit a first colored light distinct from the light emitted by second light source 1108. First light source 1106 is synchronized with global shutter camera 1102 to emit a light pulse during a specific portion of the camera’s frame exposure cycle, for example the last millisecond of a frame. Subject 1104 is illuminated under the first lighting condition during capture of a specific video frame. The emitted light can be adjusted in intensity, color, and spatial distribution to meet the requirements of the filming process and post-production workflows.

In some embodiments, second light source 1108 includes another computer-controlled LED or array of LEDs similar to first light source 1106 but configured to emit a second colored light that differs from the first colored light. Second light source 1108 is also capable of rapid on-off switching and is synchronized with global shutter camera 1102 to emit a light pulse during a different portion of the camera’s frame exposure cycle, for example the first millisecond of the subsequent frame. The distinct color combinations of first light source 1106 and second light source 1108 enable capture of video frames under two distinct lighting conditions. These frames are used in post-production to estimate surface normals 1110 and perform other visual effects.

In certain embodiments, photometric stereo techniques can be applied to obtain surface normals 1110 during post-production by analyzing intensity variations of pixels across frames illuminated by two differently colored lights. Surface normals 1110 offer detailed insights into the geometry and reflectance properties of subject 1104, supporting applications such as generating precise 3D digital representations, relighting, texture mapping, and lifelike rendering of the subject.

Accordingly, disclosed techniques of the present disclosure can be used to capture live-action scenes under two near-simultaneous lighting conditions using synchronized global shutter cameras and computer-controlled lighting. By emitting precisely timed, short duration (e.g., five milliseconds or less, one millisecond, etc.) light pulses respectively at the end of one frame and the beginning of the next, the disclosed techniques reduce motion artifacts and ensure high-quality image capture, even for dynamic subjects. The disclosed techniques reduce or eliminate the need for expensive high-speed cameras and complex post-production processes, such as extensive motion compensation, while maintaining image fidelity. The lighting operates above the human flicker fusion frequency (e.g., about 60 Hz) to create a comfortable, flicker-free environment for performers. The captured frames enable advanced post-production capabilities, including relighting, high-quality matting, surface detail estimation, and reflection suppression. These benefits streamline cinematography workflows, reduce production costs, and provide filmmakers with improved creative flexibility in lighting design and post-production editing.

The following example embodiments are also included in the present disclosure:

Example 1. A system for lighting in video production, including: a lighting system including at least a first light source and a second light source, wherein the first light source and the second light source are capable of being selectively turned on for a duration of one millisecond or less; a camera system for capturing video in sequential frames including a first frame and a second frame temporally adjacent to and after the first frame; and a synchronization system that synchronizes the first light source to activate during a last millisecond of the first frame and the second light source to activate during a first millisecond of the second frame, wherein the first light source and the second light source are both deactivated during remaining times of the first frame and of the second frame.

Example 2. The system of Example 1, wherein each of the first light source and the second light source includes a computer-controlled light-emitting diode (LED) light source.

Example 3. The system of Example 1 or Example 2, wherein the sequential frames further include a zeroth frame temporally adjacent to and before the first frame and a third frame temporally adjacent to and after the second frame.

Example 4. The system of Example 3, wherein the synchronization system further activates both the first light source and the second light source during the zeroth frame and both the first light source and the second light source during the third frame.

Example 5. The system of Example 4, wherein, during operation, each of the first light source and the second light source repeats activation at 72 flashes per second and the sequential frames have a frame rate of 96 frames per second.

Example 6. The system of Example 5, further including a motion compensation system configured to estimate and compensate for optical flow between activation of the first light source during the first frame and activation of the second light source during the second frame.

Example 7. The system of Example 6, wherein the motion compensation system estimates the optical flow by: combining the first frame and the second frame to obtain a combined frame; computing a first optical flow between the zeroth frame and the combined frame; computing a second optical flow between the combined frame and the third frame; averaging the first optical flow and the second optical flow to obtain a flow vector; and dividing the flow vector by 1000/72 to obtain an estimated flow vector between activation of the first light source and activation of the second light source.

Example 8. The system of Example 3, wherein, during operation, each of the first light source and the second light source repeats activation at 72 flashes per second and the sequential frames have a frame rate of 144 frames per second.

Example 9. The system of any one of Examples 1 through 8, wherein the camera system includes a global shutter camera that, during operation, exposes all pixels of an image detector simultaneously.

Example 10. The system of any one of Examples 1 through 9, wherein the camera system includes a global 360° shutter camera that, during operation, exhibits an exposure time equal to a frame duration of each frame of the sequential frames.

Example 11. The system of any one of Examples 1 through 10, wherein the first light source illuminates a camera-side of a subject and the second light source illuminates a background behind the subject substantially without illuminating the camera-side of the subject to obtain a silhouette of the subject during the second frame.

Example 12. The system of any one of Examples 1 through 11, wherein the first light source is configured to emit a first colored light and the second light source is configured to emit a second, different colored light.

Example 13. The system of Example 12, further including a surface normal estimation system configured to evaluate the first frame illuminated by the first light source and the second frame illuminated by the second light source and to estimate surface normals of a subject within the frames.

Example 14. A method for lighting in video production, the method including: capturing a sequence of video frames of a scene using a global shutter camera; emitting a first light pulse from one or more computer-controlled light sources, the first light pulse having a pulse duration of one millisecond or less and occurring at a terminal portion of a first frame exposure; and emitting a second light pulse from the one or more computer-controlled light sources, the second light pulse having a pulse duration of one millisecond or less and occurring at an initial portion of a second frame exposure immediately following the first frame exposure, the first and second light pulses being synchronized to occur within one millisecond of each other.

Example 15. The method of Example 14, further including repeating each of the first and second light pulses at a rate of at least 60 Hz.

Example 16. The method of Example 14 or Example 15, wherein capturing the sequence of video frames includes operating the global shutter camera at a frame rate of at least 96 frames per second.

Example 17. The method of any one of Examples 14 through 16, further including: computing an optical flow between the first light pulse in the first frame and the second light pulse in the second frame; and modifying image data of the second frame according to the computed optical flow to align pixels of the second frame with pixels of the first frame.

Example 18. A method for forming a system for video production, including: operatively coupling, to a light driver, at least one first light source and at least one second light source; operatively coupling, to the light driver, a global shutter camera for capturing video in frame sequences each including a first frame and a second frame; and synchronizing the global shutter camera and the light driver to cause the first light source to emit a first light pulse during a last millisecond of the first frame of each frame sequence and to cause the second light source to emit a second light pulse during a first millisecond of the second frame of each frame sequence.

Example 19. The method of Example 18, wherein: operatively coupling the light driver to the at least one first light source includes operatively coupling the light driver to a first plurality of light-emitting diode (LED) light sources; and operatively coupling the light driver to the at least one second light source includes operatively coupling the light driver to a second plurality of LED light sources.

Example 20. The method of Example 18 or Example 19, further including: positioning the first light source to be directed to illuminate a camera-side of a subject; and positioning the second light source to be directed to illuminate a background behind the subject substantially without illuminating the camera-side of the subject.

In some examples, the term “substantially” in reference to a given parameter, property, or condition, can refer to a degree that one skilled in the art would understand that the given parameter, property, or condition is met with a small degree of variance, such as within acceptable tolerances according to industry norms. For example, a parameter that is substantially met can be at least about 90% met, at least about 95% met, at least about 99% met, or fully met.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory” or “memory device” generally refers to any type or form of volatile or non-volatile storage device or medium capable of storing data and/or computer-readable instructions. In one example, a memory device can store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor can access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein can represent portions of a single module or application. In addition, in certain embodiments one or more of these modules can represent one or more software applications or programs that, when executed by a computing device, cause the computing device to perform one or more tasks. For example, one or more of the modules described and/or illustrated herein can represent modules stored and configured to run on one or more of the computing devices or systems described and/or illustrated herein. One or more of these modules can also represent all or portions of one or more special-purpose computers configured to perform one or more tasks.

In addition, one or more of the modules described herein can transform data, physical devices, and/or representations of physical devices from one form to another. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system for lighting in video production, comprising:
a lighting system including at least a first light source and a second light source, wherein the first light source and the second light source are capable of being selectively turned on for a duration of one millisecond or less;
a camera system for capturing video in sequential frames including a first frame and a second frame temporally adjacent to and after the first frame; and
a synchronization system that synchronizes the first light source to activate during a last millisecond of the first frame and the second light source to activate during a first millisecond of the second frame, wherein the first light source and the second light source are both deactivated during remaining times of the first frame and of the second frame.

2. The system of claim 1, wherein each of the first light source and the second light source comprises a computer-controlled light-emitting diode (LED) light source.

3. The system of claim 1, wherein the sequential frames further include a zeroth frame temporally adjacent to and before the first frame and a third frame temporally adjacent to and after the second frame.

4. The system of claim 3, wherein the synchronization system further activates both the first light source and the second light source during the zeroth frame and both the first light source and the second light source during the third frame.

5. The system of claim 4, wherein, during operation, each of the first light source and the second light source repeats activation at 72 flashes per second and the sequential frames have a frame rate of 96 frames per second.

6. The system of claim 5, further comprising a motion compensation system configured to estimate and compensate for optical flow between activation of the first light source during the first frame and activation of the second light source during the second frame.

7. The system of claim 6, wherein the motion compensation system estimates the optical flow by:
combining the first frame and the second frame to obtain a combined frame;
computing a first optical flow between the zeroth frame and the combined frame;
computing a second optical flow between the combined frame and the third frame;
averaging the first optical flow and the second optical flow to obtain a flow vector; and
dividing the flow vector by 1000/72 to obtain an estimated flow vector between activation of the first light source and activation of the second light source.

8. The system of claim 3, wherein, during operation, each of the first light source and the second light source repeats activation at 72 flashes per second and the sequential frames have a frame rate of 144 frames per second.

9. The system of claim 1, wherein the camera system comprises a global shutter camera that, during operation, exposes all pixels of an image detector simultaneously.

10. The system of claim 1, wherein the camera system comprises a global 360° shutter camera that, during operation, exhibits an exposure time equal to a frame duration of each frame of the sequential frames.

11. The system of claim 1, wherein the first light source illuminates a camera-side of a subject and the second light source illuminates a background behind the subject substantially without illuminating the camera-side of the subject to obtain a silhouette of the subject during the second frame.

12. The system of claim 1, wherein the first light source is configured to emit a first colored light and the second light source is configured to emit a second, different colored light.

13. The system of claim 12, further comprising a surface normal estimation system configured to evaluate the first frame illuminated by the first light source and the second frame illuminated by the second light source and to estimate surface normals of a subject within the frames.

14. A method for lighting in video production, the method comprising:
capturing a sequence of video frames of a scene using a global shutter camera;
emitting a first light pulse from one or more computer-controlled light sources, the first light pulse having a pulse duration of one millisecond or less and occurring at a terminal portion of a first frame exposure; and
emitting a second light pulse from the one or more computer-controlled light sources, the second light pulse having a pulse duration of one millisecond or less and occurring at an initial portion of a second frame exposure immediately following the first frame exposure, the first and second light pulses being synchronized to occur within one millisecond of each other.

15. The method of claim 14, further comprising repeating each of the first and second light pulses at a rate of at least 60 Hz.

16. The method of claim 14, wherein capturing the sequence of video frames comprises operating the global shutter camera at a frame rate of at least 96 frames per second.

17. The method of claim 14, further comprising:
computing an optical flow between the first light pulse in the first frame and the second light pulse in the second frame; and
modifying image data of the second frame according to the computed optical flow to align pixels of the second frame with pixels of the first frame.

18. A method for forming a system for video production, comprising:
operatively coupling, to a light driver, at least one first light source and at least one second light source;
operatively coupling, to the light driver, a global shutter camera for capturing video in frame sequences each including a first frame and a second frame; and
synchronizing the global shutter camera and the light driver to cause the first light source to emit a first light pulse during a last millisecond of the first frame of each frame sequence and to cause the second light source to emit a second light pulse during a first millisecond of the second frame of each frame sequence.

19. The method of claim 18, wherein:
operatively coupling the light driver to the at least one first light source comprises operatively coupling the light driver to a first plurality of light-emitting diode (LED) light sources; and
operatively coupling the light driver to the at least one second light source comprises operatively coupling the light driver to a second plurality of LED light sources.

20. The method of claim 18, further comprising:
positioning the first light source to be directed to illuminate a camera-side of a subject; and
positioning the second light source to be directed to illuminate a background behind the subject substantially without illuminating the camera-side of the subject.
